(19) United States
(12) Patent Application Publication
(10) Pub. No.: US 2022/0058397 A1
(43) Pub. Date: Feb. 24, 2022

(54) METHOD, SYSTEM, AND NON-TRANSITORY COMPUTER READABLE RECORD MEDIUM FOR EVALUATING VIDEO QUALITY USING HOMOGRAPHY ESTIMATION

(71) Applicant: LINE Plus Corporation, Seongnam-si (KR)

(72) Inventor: Dongwon Lee, Seongnam-si (KR)

(73) Assignee: LINE Plus Corporation, Seongnam-si (KR)

(21) Appl. No.: 17/405,526

(22) Filed: Aug. 18, 2021

(30) Foreign Application Priority Data
Aug. 20, 2020 (KR) 10-2020-0104590

(51) Int. Cl. G06K 9/00; G06K 9/46; G06T 7/00

(52) U.S. Cl. CPC G06K 9/00744; G06K 9/4609; G06T 2207/10016; G06T 2207/30168; G06T 7/0002

(57) ABSTRACT

A method of video quality evaluation includes obtaining, by the at least one processor, a reference area of a reference video and a degraded area of a degraded video, based on a matching area of the reference video and the degraded video, using homography estimation; correcting, by the at least one processor, at least one of the reference area and the degraded area; and measuring, by the at least one processor, video quality of the degraded video by comparing a difference between the reference area and the degraded area through a full reference scheme.

### CROSS-REFERENCE TO RELATED APPLICATION

This application claims priority to Korean Patent Application No. 10-2020-0104590, filed Aug. 20, 2020 in the Korean Intellectual Property Office (KIPO), the disclosure of which is incorporated by reference herein in its entirety.

### BACKGROUND

### 1. Field

Apparatuses and methods consistent with example embodiments of the following description relate to measuring video quality, and in particular to evaluate video quality by comparing a reference video to a degraded video using homography estimation.

### 2. Description of Related Art

With the development in a mobile internet environment, high-speed and high-capacity mobile services are becoming common. In particular, a change from an existing voice-oriented call to a video call is very quickly ongoing.

As various services are developed in a video call environment, a new business model is being discussed and there is a need to prepare a criterion and an evaluation method about quality of a video call service accordingly.

When an issue occurs in quality of service (QoS), it is necessary to quickly verify and respond to a cause and to evaluate and monitor whether QoS provided to an end user meets a desired level.

Various objective quality measurement methods have been developed to evaluate video call quality and representative methods may include methods, such as, for example, video multi-method assessment fusion (VMAF) and multi-scale structural similarity (MS-SSIM).

Among the objective quality measurement methods, a full reference (FR) scheme of comparing a difference between a reference video and a degraded video may be generally used and may relatively accurately measure a difference in quality between the two videos.

However, in the case of the FR scheme, when a distortion, such as enlargement, shift, and rotation, occurs due to a difference between devices used to exchange videos or a difference in resolution between the corresponding videos, an algorithm may recognize such a change as a degradation in quality internally and may derive a relatively low comparison result value.

### SUMMARY

Provided is a method of measuring video quality of a matching portion between two videos, for example, a reference video and a degraded video, using homography estimation when mismatch occurs between the reference video and the degraded video in a full reference (FR) video quality measurement method.

Provided also is a method of acquiring a more accurately matching portion between two videos, for example, a reference video and a degraded video, by readjusting an aspect ratio and adjusting a pixel offset using feature points matched between the reference video and the degraded video to measure video quality.

According to an aspect of the disclosure, a method performed by a computer system including at least one processor configured to execute computer-readable instructions included in a memory may include obtaining, by the at least one processor, a reference area of a reference video and a degraded area of a degraded video, based on a matching area of the reference video and the degraded video, using homography estimation; correcting, by the at least one processor, at least one of the reference area and the degraded area; and measuring, by the at least one processor, video quality of the degraded video by comparing a difference between the reference area and the degraded area through a full reference scheme.

The method may further include at least one of: cropping the reference area in the reference video; or adjusting a scale of the degraded area based on the reference area.

The method may further include obtaining at least one of: a reference mode value from a homography estimation result of each frame of the reference video; and a degraded mode value from a homography estimation result of each frame of the degraded video; and correcting at least one of: the reference area by applying the reference mode value to each frame of the reference video; and the degraded area by applying the degraded mode value to each frame of the degraded video.

The method may further include determining a scale factor for adjusting a scale of the degraded area using a feature point that meets a predetermined condition among a plurality of feature points matched between the reference area and the degraded area; and adjusting the scale of the degraded area based on an aspect ratio corresponding to the scale factor.

The determining may include selecting at least two matching feature points present in an oblique direction with a predetermined gradient or more in each of the reference area and the degraded area; and determining the scale factor based on a difference between feature points selected in the reference area and feature points selected in the degraded area.

The correcting may include adjusting an offset of the degraded area based on a difference between at least a portion of feature points among the plurality of feature points matched between the reference area and the degraded area.

The obtaining the reference area and the degraded area may include extracting a feature point in each of the reference video and the degraded video; and obtaining a similarity between the feature point of the reference video and the feature point of the degraded video through the homography estimation.

The obtaining the reference area and the degraded area may further include extracting a plurality of feature points in each of the reference video and the degraded video; and removing an outlier feature point from among the plurality of feature points extracted from the reference video and the degraded video.

The method may further include performing, by the at least one processor, a perspective transform on at least one of the reference area and the degraded area before performing the correcting.

According to another aspect of the disclosure, a method performed by a computer system including at least one processor configured to execute computer-readable instructions included in a memory may include determining, by the at least one processor, a scale factor for adjusting a scale of a source image using a feature point that meets a predetermined condition among a plurality of feature points matched between a destination image and the source image; and adjusting, by the at least one processor, the scale of the source image at an aspect ratio corresponding to the scale factor.

According to another aspect of the disclosure a non-transitory computer-readable record medium storing computer instructions that, when executed by a processor, cause the processor to perform the above methods.

According to another aspect of the disclosure, a computer system may include a memory storing computer-readable instructions; at least one processor configured to execute the computer-readable instructions to: obtain a reference area of a reference video and a degraded area of a degraded video, based on a matching area of the reference video and the degraded video, using homography estimation; correct at least one of the reference area and the degraded area; and measure video quality of the degraded video by comparing a difference between the reference area and the degraded area through a full reference scheme.

The at least one processor may be further configured to execute the computer-readable instructions to, at least one of: crop the reference area in the reference video; or adjust a scale of the degraded area based on the reference area.

The at least one processor may be further configured to execute the computer-readable instructions to obtain at least one of: a reference mode value from a homography estimation result of each frame of the reference video; and a degraded mode value from a homography estimation result of each frame of the degraded video; and correct at least one of: the reference area by applying the reference mode value to each frame of the reference video; and the degraded area by applying the degraded mode value to each frame of the degraded video.

The at least one processor may be further configured to execute the computer-readable instructions to: determine a scale factor for adjusting a scale of the degraded area using a feature point that meets a predetermined condition among a plurality of feature points matched between the reference area and the degraded area; and adjust the scale of the degraded area based on an aspect ratio corresponding to the scale factor.

The at least one processor may be further configured to execute the computer-readable instructions to: select at least two matching feature points present in an oblique direction with a predetermined gradient or more in each of the reference area and the degraded area, and determine the scale factor based on a difference between feature points selected in the reference area and feature points selected in the degraded video.

The at least one processor may be further configured to execute the computer-readable instructions to adjust an offset of the degraded area based on a difference between at least a portion of feature points among the plurality of feature points matched between the reference area and the degraded area.

The at least one processor may be further configured to execute the computer-readable instructions to: extract a feature point in each of the reference video and the degraded video, and obtain a similarity between the feature point of the reference video and the feature point of the degraded video through the homography estimation.

The at least one processor may be further configured to execute the computer-readable instructions to perform a perspective transform on at least one of the reference area and the degraded area before performing the correcting.

According to another aspect of the disclosure, a computer system may include: a memory comprising computer-readable instructions; at least one processor configured to execute the computer-readable instructions to: determine a scale factor for adjusting a scale of a source image using a feature point that meets a predetermined condition among a plurality of feature points matched between a destination image and the source image, and adjust the scale of the source image at an aspect ratio corresponding to the scale factor.

### BRIEF DESCRIPTION OF THE FIGURES

The above and/or other aspects will be more apparent by describing certain example embodiments, with reference to the accompanying drawings, in which:

FIG. 1 is a diagram illustrating an example of a computer system according to at least one example embodiment;

FIG. 2 is a diagram of a full reference (FR) video quality measurement process according to at least one example embodiment;

FIG. 3 is a diagram of an entire architecture implemented for video quality measurement on a computer system and a video quality measurement method performed by the computer system according to at least one example embodiment;

FIGS. 4 and 5 show a process of extracting a feature point in each image according to at least one example embodiment;

FIG. 6 is a diagram of a process of selecting a feature point matched between images according to at least one example embodiment;

FIGS. 7 and 8 are diagrams of a homography estimation process according to at least one example embodiment;

FIG. 9 is a diagram of a perspective transform process according to at least one example embodiment;

FIGS. 10, 11, 12, and 13 are diagrams of an image correction process for acquiring matching two images according to at least one example embodiment; and

FIGS. 14 and 15 are diagrams of an image correction process for acquiring matching two images according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises,” “includes,” “comprising,” and/or “including,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to forward and/or distribute the computer programs, program code, instructions, or some combination thereof, over a network. The remote computing system may forward and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for measuring video quality.

The example embodiments including the disclosures described herein may retrieve a matching portion between two videos, for example, a reference video and a degraded video, and measure video quality of the matching portion using homography estimation when mismatch occurs between the reference video and the degraded video in a full reference (FR) video quality measurement method due to a distortion such as enlargement, shift, and rotation.

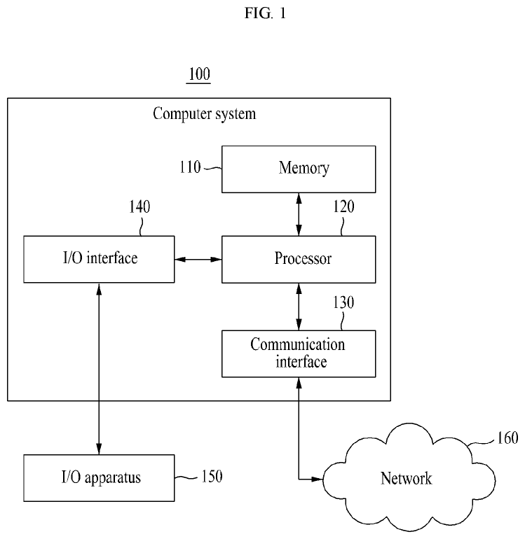

FIG. 1 is a diagram showing an example of a computer system according to at least one example embodiment. Referring to FIG. 1, a video quality measurement system according to example embodiments may be implemented by a computer system 100 of FIG. 1.

Referring to FIG. 1, the computer system 100 may include a memory 110, a processor 120, a communication interface 130, and an input/output (I/O) interface 140 as components to perform a video quality measurement method according to example embodiments.

The memory 110 may include a permanent mass storage device, such as random access memory (RAM), a read only memory (ROM), and a disk drive, as a non-transitory computer-readable record medium. The permanent mass storage device, such as ROM and disk drive, may be included in the computer system 100 as a permanent storage device separate from the memory 110. Also, an OS and at least one program code may be stored in the memory 110. Such software components may be loaded to the memory 110 from another non-transitory computer-readable record medium separate from the memory 110. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 110 through the communication interface 130, instead of the non-transitory computer-readable record medium. For example, software components may be loaded to the memory 110 of the computer system 100 based on a computer program installed by files received through a network 160.

The processor 120 may be configured to process instructions of a computer program by performing basic arithmetic operations, logic operations, and I/O operations. The computer-readable instructions may be provided from the memory 110 or the communication interface 130 to the processor 120. For example, the processor 120 may be configured to execute received instructions in response to a program code stored in the storage device, such as the memory 120.

The communication interface 130 may provide for communication between the computer system 100 and another apparatus over the network 160. For example, the processor 120 of the computer system 100 may forward a request or an instruction created based on the program code stored in the storage device such as the memory 110, to other apparatuses over the network 160 under control of the communication interface 130. Inversely, a signal, an instruction, data, a file, etc., from another apparatus may be received at the computer system 100 through the communication interface 130 of the computer system 100 and the network 160. For example, a signal, an instruction, data, etc., received through the communication interface 130 may be forwarded to the processor 120 or the memory 110, and a file, etc., may be stored in a storage medium, for example, the permanent storage device, further includable in the computer system 100.

The communication scheme is not limited and may include a near field wireless communication scheme between devices as well as a communication scheme using a communication network (e.g., a mobile communication network, wired Internet, wireless Internet, a broadcasting network, etc.) includable in the network 160. For example, the network 160 may include at least one of network topologies that include a personal area network (PAN), a local area network (LAN), a campus area network (CAN), a metropolitan area network (MAN), a wide area network (WAN), a broadband network (BBN), and the Internet. Also, the network 160 may include at least one of network topologies that include a bus network, a star network, a ring network, a mesh network, a star-bus network, a tree or hierarchical network, and the like. However, they are provided as examples only.

The I/O interface 140 may be a device used for interfacing with an I/O apparatus 150. For example, an input device may include a device, such as a microphone, a keyboard, a camera, etc., and an output device may include a device, such as a display and a speaker. As another example, the I/O interface 140 may be a device for interfacing with an apparatus in which an input function and an output function are integrated into a single function, such as a touchscreen. The I/O apparatus 150 may be configured as a single device with the computer system 100.

According to other example embodiments, the computer system 100 may include a number of components greater than or less than a number of components shown in FIG. 1. However, there is no need to clearly illustrate many components according to the related art. For example, the computer system 100 may be configured to include at least a portion of the I/O apparatus 150, or may further include other components, for example, a transceiver, a camera, various sensors, and a database.

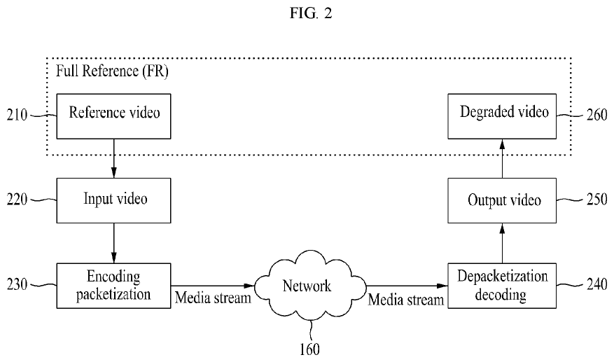

FIG. 2 is a diagram of an FR video quality measurement process according to at least one example embodiment.

Referring to FIG. 2, a video quality measurement system may provide a reference video 210 as an input video 220 of a transmission device.

The transmission device may convert the input video 220 to a form of a media stream through an encoding packetization 230, and transmit the media stream to another device, for example, a reception device through the network 160.

The reception device may convert the media stream received from the transmission device to an output video 250 in a displayable form through a depacketization decoding 240 and display the output video 250 on a screen.

The video quality measurement system may acquire the output video 250 displayed on the screen of the reception device as a degraded video 260 through photographing or capturing and measures the video quality using an FR video quality measurement scheme.

The FR video quality measurement scheme refers to a scheme of comparing a difference between the reference video 210 and the degraded video 260 with an algorithm using a visual perceptive characteristic of a human.

The aforementioned FR video quality measurement scheme may measure the difference between the reference video 210 and the degraded video 260 and may be generally applied to a performance measurement scheme of a video encoder, and, in the recent times, is used for quality evaluation or monitoring of a video streaming service.

To use the FR video quality measurement scheme, the reference video 210 with a specific mark is provided as the input video 220 of the transmission device, the specific mark is recognized in a video being displayed on the screen of the reception device, and the degraded video 260 having the same mark as that of the reference video 210 is retrieved.

The video quality measurement system may measure the video quality by retrieving the degraded video 260 corresponding to the reference video 210 with respect to the reference video 210 and by comparing the difference between the reference video 210 and the degraded video 260.

If the transmission device and the reception device are the same type of devices or if a resolution is identical between two videos, there is no difference between the two videos and thus, the FR scheme may be easily used.

However, if the transmission device and the reception device are different types of devices, or if a resolution is different between two videos, a difference may occur between the two videos, resulting in a low quality score even though the FR scheme is used.

Also, even though the transmission device and the reception device are the same type of devices, a difference may occur due to an enlargement or a reduction in a video scale, results in measuring an inaccurate value with the FR scheme.

That is, if types of devices are different or if a resolution or a scale between the reference video 210 and the degraded video 260 is different, distortion, such as enlargement, shift, and rotation, may occur and the RF scheme may not be applied accordingly.

The example embodiment may retrieve a matching portion between the reference video 210 and the degraded video 260 using homography estimation when mismatch occurs between the reference video 210 and the degraded video 260 and may measure video quality thereof in an FR video quality measurement method.

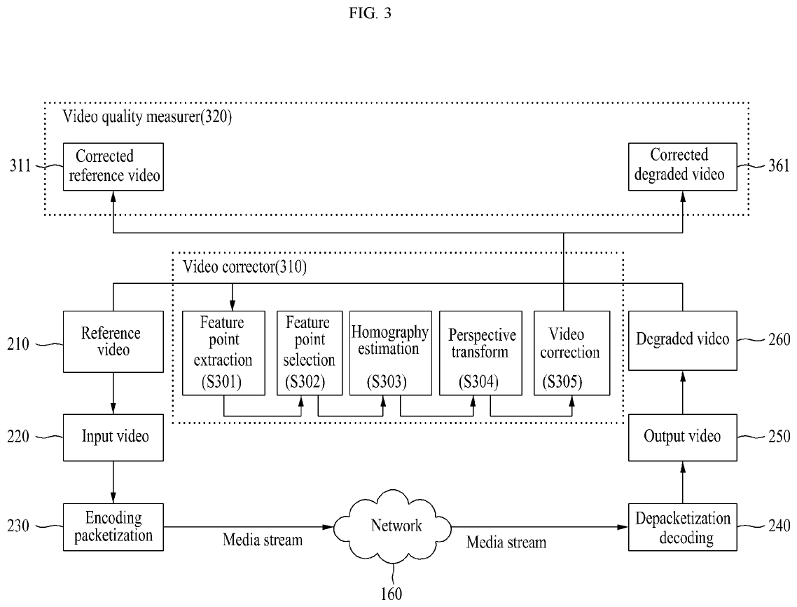

FIG. 3 is a diagram of an entire architecture implemented for video quality measurement on a computer system and a video quality measurement method performed by the computer system according to at least one example embodiment.

Referring to FIG. 3, the processor 120 may include a video corrector 310 configured to perform a video correction for matching the reference video 210 and the degraded video 260 and a video quality measurer 320 configured to measure video quality through an FR scheme of comparing a difference between a corrected reference video 311 and a corrected degraded video 361 through the video corrector 310.

Components of the processor 120 may be representations of different functions performed by the processor 120 under a control instruction provided in response to at least one program code. For example, the video corrector 310 may be used as a functional representation such that the processor 120 may control the computer system 100 to perform a video correction.

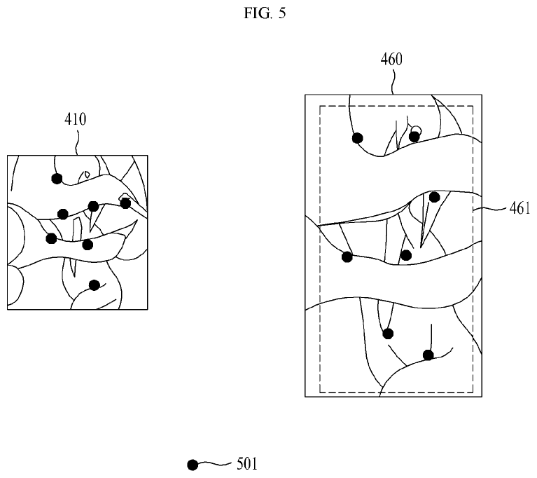

The processor 120 and the components of the processor 120 may perform operations included in a video quality measurement method of FIG. 5. For example, the processor 120 and the components of the processor 120 may be configured to execute an instruction according to a code of an OS included in the memory 110 and the aforementioned at least one program code. Here, the at least one program code may correspond to a code of a program implemented to process the video quality measurement method.

The video quality measurement method may not be performed in illustrated order and a portion of operations may be omitted or an additional process may be further included.

The processor 120 may load, to the memory 110, a program code stored in a program file for the video quality measurement method. For example, the program file for the video quality measurement method may be stored in a permanent storage device separate from the memory 110. The processor 120 may control the computer system 100 such that the program code may be loaded from the program file stored in the permanent storage device to the memory 110 through a bus. Here, the processor 120 and the video corrector 310 and the video quality measurer 320 included in the processor 120 may be different functional representations of the processor 120 for performing the following operations by executing an instruction of a portion corresponding to the program code loaded to the memory 110. To execute operations included in the video quality measurement method, the processor 120 and the components of the processor 120 may directly process an operation or may control the computer system 100 in response to a control instruction.

The same description of FIG. 2 may apply to the reference video 210 and the degraded video 260 each of which video quality is to be measured. Therefore, further description is omitted.

The video corrector 310 may retrieve an accurate matching point between the reference video 210 and the degraded video 260 using homography estimation and may match two videos, that is, the reference video 210 and the degraded video 260 by correcting, for example, scaling and cropping, at least one of the reference video 210 and the degraded video 260.

For example, the video corrector 310 may match two videos, that is, the reference video 210 and the degraded video 260, using a scheme of retrieving a portion that overlaps the degraded video 260 from the reference video 210 based on a least common multiple of the reference video 210 and the degraded video 260 and cropping a remaining portion and reducing the degraded video 260.

A video correction process for matching the reference video 210 and the degraded video 260 may include operation S301 of extracting a feature point in each of the reference video 210 and the degraded video 260; operation S302 of selecting at least a portion of the extracted feature points; operation S303 of retrieving similarity between the feature points of the two videos, that is, the reference video 210 and the degraded video 260, using a homography estimation algorithm; operation S304 of restoring a distorted video through a perspective transform; and operation S305 of retrieving and correcting a matching point between the two videos.

The aforementioned video correction process including operations S301 to S305 may not be performed in illustrated order. A portion of operations may be omitted or an additional process may be further included.

Hereinafter, the video correction process including operations S301 to S305 for matching the reference video 210 and the degraded video 260 is further described.

In operation S301, the video corrector 310 may extract, in each image, invariant feature points for a scale and a rotation before applying a homography algorithm.

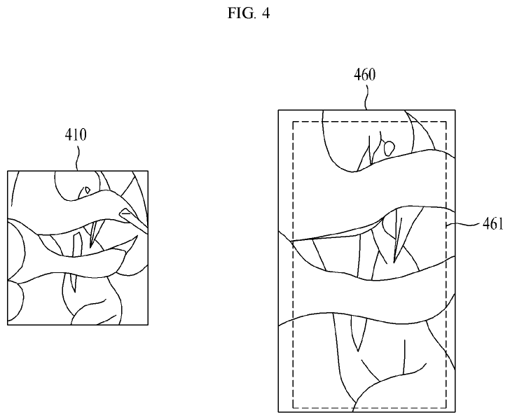

Prior to extracting a feature point, a destination image and a source image to be corrected are defined. Referring to FIG. 4, the reference video 210 that is a transmission video may be defined as the destination image 410 and the degraded video 260 that is a reception video may be defined as the source image 460. Here, the video corrector 310 may set a region of interest (ROI) 461 in the source image 460. The ROI 461 may be determined through a user setting or may be determined as an area predefined for the source image 460.

Referring to FIG. 5, the video corrector 310 may extract feature points 501 in each of the destination image 410 and the source image 460. The feature point 501 may refer to a portion that includes information distinguished from other portions in a corresponding image and represents a keypoint distinguishable by the same feature even though a change in scale, shift, or rotation occurs. For example, the video corrector 310 may extract the feature points 501 in the destination image 410 and the source image 460 using Scale-Invariant Feature Transform (SIFT), Speeded Up Robust Features (SURF), Oriented FAST and Rotated BRIEF (ORB) algorithms, and the like.

In operation S302, the video corrector 310 may select a feature point matched between two images, for example, the destination image 410 and the source image 460, from among the feature points 501 extracted in the destination image 410 and the source image 460.

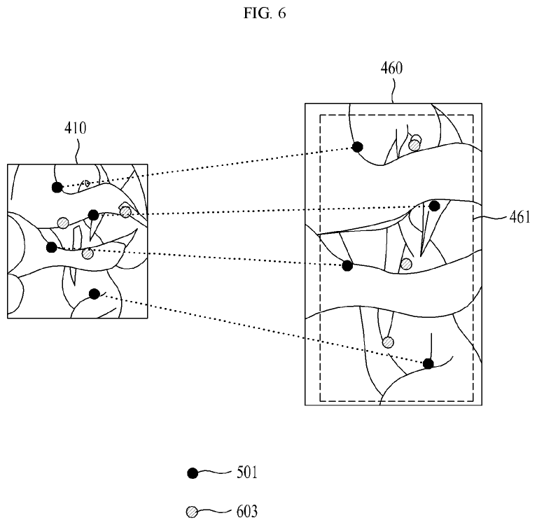

There is a limit on comparison using all of the feature points 501 extracted in the respective images. Referring to FIG. 6, it is necessary to filter out an insignificant outlier 603 among the feature points 501 extracted in the destination image 410 and the source image 460. For example, the video corrector 310 may retrieve and remove the outlier 603 deviated from a normal distribution from among the feature points 501 using a Random Sample Consensus (RANSAC) algorithm. As another example, the video corrector 310 may calculate a distance between the feature points 501 and may classify and remove a point corresponding to a distance outside a threshold value into the outlier 603.

Once operation S302 of selecting the feature points 501 in the destination image 410 and the source image 460 is completed, the video corrector 310 may perform homography estimation between the destination image 410 and the source image 460 in operation S303.

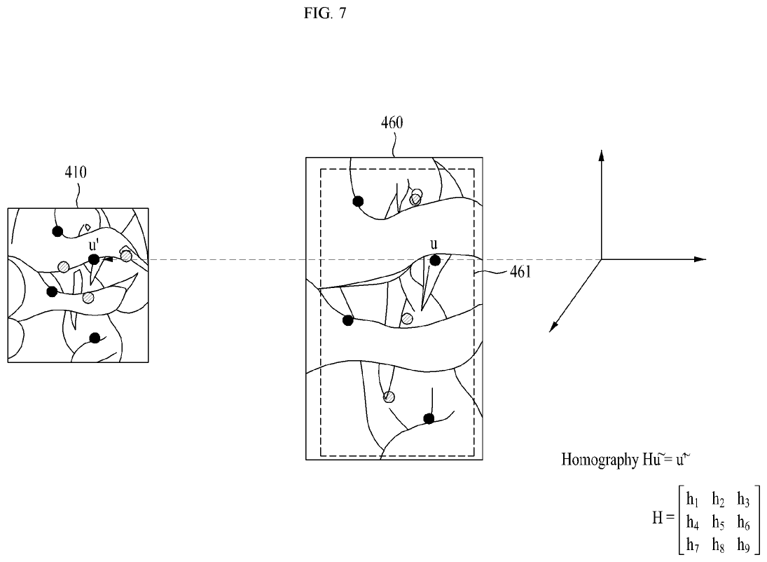

Referring to FIG. 7, the video corrector 310 may retrieve a geometrical similarity between a feature point u′ of the destination image 410 and a feature point u of the source image 460 using the homography estimation algorithm. Using the homography estimation algorithm, the video corrector 301 may calculate a homography matrix H that is a similarity representation between feature points (u, u′).

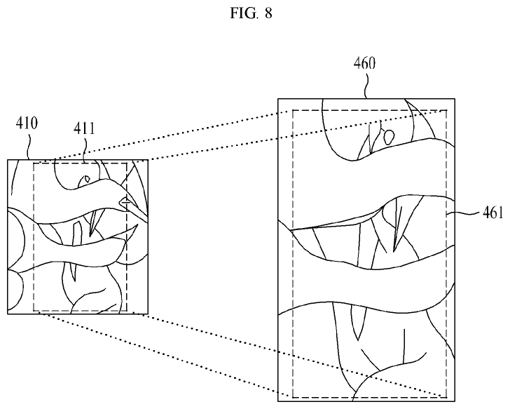

Referring to FIG. 8, the video corrector 310 may calculate an area (hereinafter, a matching area) 411 that matches the ROI 461 of the source image 460 in the destination image 410 based on a homography estimation result.

As described above, if a homography feature is discovered with respect to feature points remaining after removing the unnecessary outlier 603 from among the feature points 501 extracted in the destination image 410 and the source image 460, the video corrector 310 may retrieve a matching portion between the destination image 410 and the source image 460.

In operation S304, the video corrector 310 may additionally apply perspective transform to consider distortions of various elements included in the destination image 410 and the source image 460.

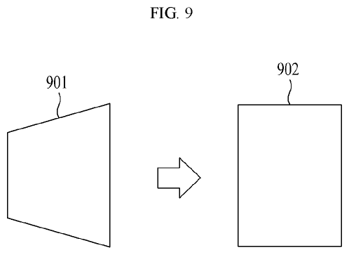

Referring to FIG. 9, the perspective transform refers to an algorithm capable of restoring an image 901 distorted in various shapes as well as a change in scale, shift, or rotation, to an image 902 in an original shape. The perspective transform algorithm may be used to restore a distorted video by a camera photographing to an original state. Operation S304 that is a perspective transform operation may be selectively applied and may not be applied if there is no perspective change in the destination image 410 and the source image 460.

In operation S305, the video corrector 310 may perform an image correction of matching the destination image 410 and the source image 460.

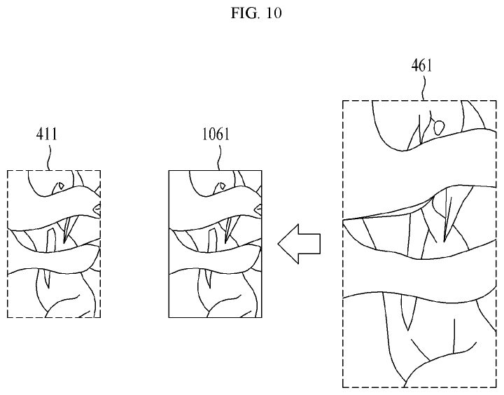

Referring to FIG. 10, the video corrector 310 may generate a new source image 1061 by cropping the matching area 411 in the destination image 410 and by adjusting a scale of the ROI 461 of the source image 460, for example, scaling down the same to fit the matching area 411.

Through an image correction of matching the destination image 410 and the source image 460, the video corrector 310 may acquire the matching area 411 as the corrected reference video 311 and may acquire the new source image 1061 as the corrected degraded video 361.

Hereinafter, a process of adjusting a scale of the ROI 461 is described.

In the case of adjusting a scale of the ROI 461 of the source image 460, if the matching area 411 is not an exact rectangle, an accurate magnification may not be calculated from an image size of the matching area 411.

Adjusting a scale of the ROI 461 may be performed by an algorithm for retrieving a scale factor that represents an aspect ratio between the matching area 411 of the destination image 410 and the ROI 461 of the source image 460.

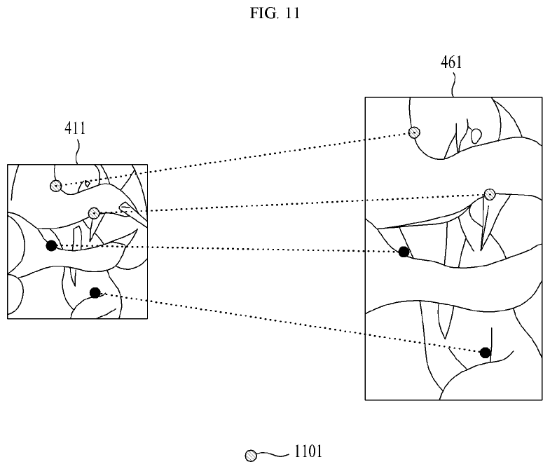

Referring to FIG. 11, the video corrector 310 may retrieve a scale factor for adjusting a scale of the ROI 410 using feature points 1101 that meet a predetermined (or, alternatively, desired) criterion among feature points matched between the matching area 411 of the destination image 410 and the ROI 461 of the source image 460.

The video corrector 310 may select the feature points 1101 present in an oblique direction with a predetermined (or, alternatively, desired) gradient or more that cross a wide area of a corresponding image. That is, the video corrector 310 may select and use two feature points 1101 having a difference between X-axial values and a difference between Y-axial values greater than or equal to a threshold value.

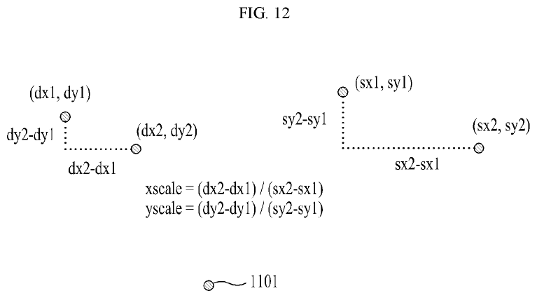

Referring to FIG. 12, the video corrector 310 may select two feature points (dx1, dy1) and (dx2, dy2) present in the oblique direction in the matching area 411 and may select two feature points (sx1, sy1) and (sx2, sy2) that match the two feature points (dx1, dy1) and (dx2, dy2) selected in the matching area 411, in the ROI 461.

A ratio of the two feature points (dx1, dy1) and (dx2, dy2) in the matching area 411 is equal to a ratio of the two feature points (sx1, sy1) and (sx2, sy2) in the ROI 461. Therefore, using this, a scale factor for adjusting a scale of the ROI 461 may be determined according to the following Equations 1 through 3.

xscale=(dx2−dx1)/(sx2−sx1) [Equation 1]

yscale=[(dy2−dy1)/(sy2−sy1)] [Equation 2]

scale factor=xscale, yscale [Equation 3]

The video corrector 310 may generate the new source image 1061 that matches the matching area 411 by adjusting the scale of the ROI 461 at an aspect ratio corresponding to the scale factor.

Since the source image 1061 is an image corrected through scaling, a minute pixel offset with the matching area 411 of the destination image 410 may be present. Therefore, offset adjustment may be required for the source image 1061.

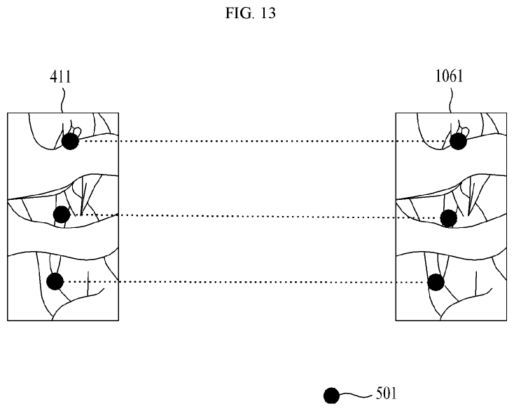

Referring to FIG. 13, the video corrector 310 may use a difference between at least a portion of the feature points 501 matched between the ROI 411 and the source image 1061 to adjust the offset. The video corrector 310 may shift the source image 1061 by an offset value by applying an average difference between feature points of the matching area 411 and feature points of the source image 1061 as the offset value.

The image correction process described with reference to FIGS. 11 through 13 corresponds to a frame-by-frame approach scheme performed based on an image frame unit according to an embodiment.

Hereinafter, another example of a process of adjusting a scale of the ROI 461 is described.

Since a ratio and an offset for image correction may differ for each image frame, a statistical ratio and offset for the entire frames may be required for adjusting the scale of the image.

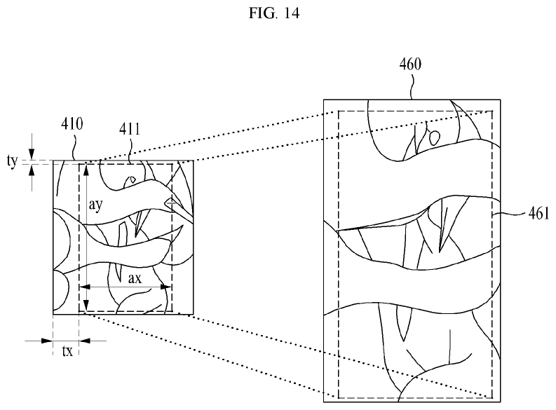

Referring to FIG. 14, the video corrector 310 may acquire a translation value (tx, ty) or a scale value (ax, ay) through homography estimation for each of image frames of the destination image 410 and the source image 460. That is, in the case of image translation, a constant representing a translation value between images may be included in a homography matrix H. Likewise, in the case of scale adjustment, a constant representing a scale value between images may be included in the homography matrix H.

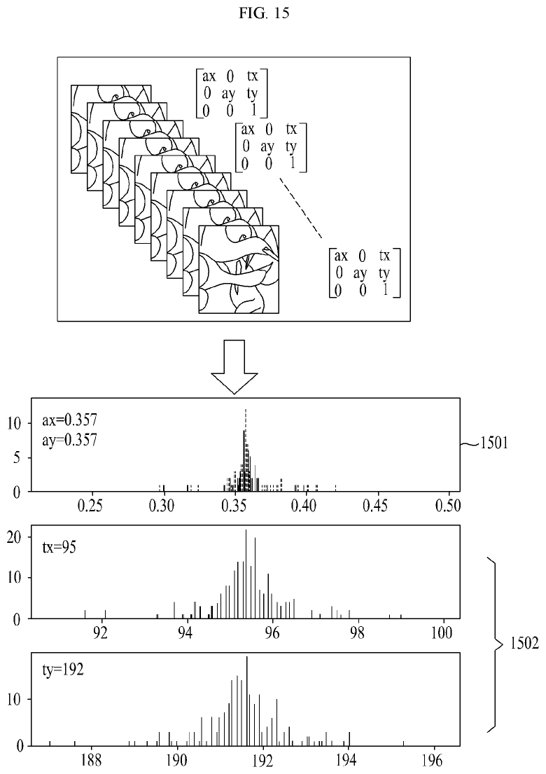

The video corrector 310 may calculate a mode value for a translation value or a scale value corresponding to a homography estimation result of each image frame. Referring to FIG. 15, the video corrector 310 may determine a mode value of a scale value through a scale histogram 1501 that represents a scale value distribution of an image frame and may determine a mode value of a translation value through a histogram 1502 that represents a translation value distribution of an image frame. A mode value of all the frames may be used as a target value for image correction. The video corrector 310 may perform an image correction of matching the destination image 410 and the source image 460 in the same condition for the entire frames by applying the determined mode value to all of the image frames.

Accordingly, the video corrector 310 may generate matching images, that is, the matching area 411 and the source image 1061, in a form optimized for video quality measurement through the image correction on the destination image 410 and the source image 460.

Referring again to FIG. 3, the video quality measurer 320 may measure video quality through an FR scheme of receiving, from the video corrector 310, the matching area 411 acquired through the image correction as the corrected reference video 311 and receiving the source image 1061 as the corrected degraded video 361, and comparing a difference between the corrected reference video 311 and the corrected degraded video 361.

According to some example embodiments, video quality of a matching portion between two videos may be measured, such as a reference video and a degraded video, using homography estimation when mismatch occurs between the reference video and the degraded video in an FR video quality measurement method.

Also, according to some example embodiments, it is possible to measure video quality by acquiring a more accurately matching portion between two videos, such as a reference video and a degraded video, through readjustment of an aspect ratio and readjustment of a pixel offset using feature points matched between the reference video and the degraded video.

The systems or the apparatuses described herein may be implemented using hardware components, software components, and/or a combination thereof. For example, a processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method performed by a computer system including at least one processor configured to execute computer-readable instructions included in a memory, the method comprising:
obtaining, by the at least one processor, a reference area of a reference video and a degraded area of a degraded video, based on a matching area of the reference video and the degraded video, using homography estimation;
correcting, by the at least one processor, at least one of the reference area and the degraded area; and
measuring, by the at least one processor, video quality of the degraded video by comparing a difference between the reference area and the degraded area through a full reference scheme.

2. The method of claim 1, wherein the correcting comprises at least one of:
cropping the reference area in the reference video; or
adjusting a scale of the degraded area based on the reference area.

3. The method of claim 1, wherein the correcting comprises:
obtaining at least one of:
a reference mode value from a homography estimation result of each frame of the reference video; and
a degraded mode value from a homography estimation result of each frame of the degraded video; and
correcting at least one of:
the reference area by applying the reference mode value to each frame of the reference video; and
the degraded area by applying the degraded mode value to each frame of the degraded video.

4. The method of claim 1, wherein the correcting comprises:
determining a scale factor for adjusting a scale of the degraded area using a feature point that meets a predetermined condition among a plurality of feature points matched between the reference area and the degraded area; and
adjusting the scale of the degraded area based on an aspect ratio corresponding to the scale factor.

5. The method of claim 4, wherein the determining comprises:
selecting at least two matching feature points present in an oblique direction with a predetermined gradient or more in each of the reference area and the degraded area; and
determining the scale factor based on a difference between feature points selected in the reference area and feature points selected in the degraded area.

6. The method of claim 4, wherein the correcting comprises:
adjusting an offset of the degraded area based on a difference between at least a portion of feature points among the plurality of feature points matched between the reference area and the degraded area.

7. The method of claim 1, wherein the obtaining the reference area and the degraded area comprises:
extracting a feature point in each of the reference video and the degraded video; and
obtaining a similarity between the feature point of the reference video and the feature point of the degraded video through the homography estimation.

8. The method of claim 7, wherein the obtaining the reference area and the degraded area further comprises:
extracting a plurality of feature points in each of the reference video and the degraded video; and
removing an outlier feature point from among the plurality of feature points extracted from the reference video and the degraded video.

9. The method of claim 1, further comprising:
performing, by the at least one processor, a perspective transform on at least one of the reference area and the degraded area before performing the correcting.

10. A method performed by a computer system including at least one processor configured to execute computer-readable instructions included in a memory, the method comprising:
determining, by the at least one processor, a scale factor for adjusting a scale of a source image using a feature point that meets a predetermined condition among a plurality of feature points matched between a destination image and the source image; and
adjusting, by the at least one processor, the scale of the source image at an aspect ratio corresponding to the scale factor.

11. A non-transitory computer-readable record medium storing computer instructions that, when executed by a processor, cause the processor to perform the method of claim 1.

12. A computer system comprising:
a memory storing computer-readable instructions;
at least one processor configured to execute the computer-readable instructions to:
obtain a reference area of a reference video and a degraded area of a degraded video, based on a matching area of the reference video and the degraded video, using homography estimation;
correct at least one of the reference area and the degraded area; and
measure video quality of the degraded video by comparing a difference between the reference area and the degraded area through a full reference scheme.

13. The computer system of claim 12, wherein the at least one processor is further configured to execute the computer-readable instructions to, at least one of:
crop the reference area in the reference video; or
adjust a scale of the degraded area based on the reference area.

14. The computer system of claim 12, wherein the at least one processor is further configured to execute the computer-readable instructions to obtain at least one of:
a reference mode value from a homography estimation result of each frame of the reference video; and
a degraded mode value from a homography estimation result of each frame of the degraded video; and
correct at least one of:
the reference area by applying the reference mode value to each frame of the reference video; and
the degraded area by applying the degraded mode value to each frame of the degraded video.

15. The computer system of claim 12, wherein the at least one processor is further configured to execute the computer-readable instructions to:
determine a scale factor for adjusting a scale of the degraded area using a feature point that meets a predetermined condition among a plurality of feature points matched between the reference area and the degraded area; and
adjust the scale of the degraded area based on an aspect ratio corresponding to the scale factor.

16. The computer system of claim 15, wherein the at least one processor is further configured to execute the computer-readable instructions to:
select at least two matching feature points present in an oblique direction with a predetermined gradient or more in each of the reference area and the degraded area, and
determine the scale factor based on a difference between feature points selected in the reference area and feature points selected in the degraded video.

17. The computer system of claim 15, wherein the at least one processor is further configured to execute the computer-readable instructions to adjust an offset of the degraded area based on a difference between at least a portion of feature points among the plurality of feature points matched between the reference area and the degraded area.

18. The computer system of claim 12, wherein the at least one processor is further configured to execute the computer-readable instructions to:
extract a feature point in each of the reference video and the degraded video, and
obtain a similarity between the feature point of the reference video and the feature point of the degraded video through the homography estimation.

19. The computer system of claim 12, wherein the at least one processor is further configured to execute the computer-readable instructions to perform a perspective transform on at least one of the reference area and the degraded area before performing the correcting.

20. A computer system comprising:
a memory comprising computer-readable instructions
at least one processor configured to execute the computer-readable instructions to:
determine a scale factor for adjusting a scale of a source image using a feature point that meets a predetermined condition among a plurality of feature points matched between a destination image and the source image, and
adjust the scale of the source image at an aspect ratio corresponding to the scale factor.
